(19) United States
(12) Patent Application Publication
(10) Pub. No.: US 2004/0238696 A1
(43) Pub. Date: Dec. 2, 2004

(54) Hanging object support system and method of use

(76) Inventor: Augie Herrera, Moreno Valley, CA (US)

Correspondence Address: Richard L. Myers, MYERS DAWES & ANDRAS, Suite 1150, 19900 MacArthur Blvd., Irvine, CA, 92612, US

(21) Appl. No.: 10/447,450

(22) Filed: May 28, 2003

(51) Int. Cl. F16L 3/00

(52) U.S. Cl. 248/63

(57) ABSTRACT

A system for supporting an elongate object along a structure includes a first clip having a first base section and a first operating section and a second clip having a second base section and a second operating section. Means is providing for attaching to the structure the first base section of the first clip and the second base section of the second clip in a spaced relationship. A cord is coupled to the first operating section of the first clip and the second operating section of the second clip. The first and second operating sections are removably attached to the first base section and the second base section respectively. The cord is adapted to support the elongate object along the structure. An associated method includes the step of removably attaching the first operating section to the first base section and the second operation section to the second base section to removably support the cord and the object along the structure.

### BACKGROUND OF THE INVENTION

1. Field of the Invention

This invention relates generally to systems and methods for supporting objects such as Christmas lights, banners and signs on a building or other structure.

2. Discussion of the Related Art

The hanging of Christmas lights is a tedious and cumbersome process. The lights are commonly hung along elevated locations, such as the top edge of a wall or the eve of a house. In order to hang a string of Christmas lights, one has been required to work in close proximity to this elevated position, typically using a ladder. Nails, hooks, clips and staples are currently used to attach the string of lights directly to the eve of the house or building. To mount an entire string of lights along the eve of a house for example, it has been necessary to move the ladder and climb up and down the ladder in order to place each one or two nails or hooks.

The placement of banners or signs on buildings has similarly required the use of nails, hooks, clips, or staples to support the sign along the eve. This process has been even further complicated by the weight and size of the associated banner or sign.

### SUMMARY OF THE INVENTION

In accordance with the present invention, a system is provided with a clip mechanism including a base section and an operating section. This operating portion is removably attachable to the base section to form the clip.

In one embodiment of this system, the base section of the clips is permanently attached to the eve of the house. The operating section from several clips can then be strung along a cord or wire. The Christmas lights or banners can then be attached to the cord or wire by plastic clips. This sub-system, including the operating section of the clips, can then be elevated and mounted to the associated base sections of the clips in order to string the cord or wire and attached Christmas lights or banner to the eve of the house. This attachment can be facilitated using a pole operable from ground level In this case, no ladder is required to couple or uncouple the clips. This not only facilitates the ease, simplicity and speed of mounting the associated Christmas lights or banner, but also greatly increases the safety of the person operating the system.

In one aspect, the system is provided for supporting an elongate object along a structure, such as a house. The system includes a first clip, having a first base section and first operating section removably attached to the first base section. A similar second clip includes a second base section and a second operating section. Means is provided for attaching the first base section and the second base section in a spaced relationship to the eve of the house. A cord is coupled to the first operating section and the second operating section forming a sub-assembly to which the Christmas lights or banner can be attached. The first operating section of the first clip is removably coupled to the first base section, and the second operating section of the second clip is removably coupled to the second base section, to support the Christmas lights or banner along the eve of the structure.

In another aspect, a method is disclosed for removably supporting an elongate object along a structure. This method includes the step of providing the first clip with first base section and first operating section, and a second clip with a second base section and a second operating section. The base sections of the first and second clip are mounted to the structure in a spaced relationship. The first operating section and the second operating sections are then strung onto a cord or wire. The elongate object is attached to the cord or wire and the resulting subassembly removably attached by coupling the first operating section to the first base section and the second operating section to the second base section along the structure.

Another aspect of the invention includes a remote operating system for removably coupling an operating section of the clip to a base section of the clip, the operating system having an annulus and a plunger movable from a locked position to a free position to engage the base section of the clip. The operating system includes an elongate pole having a proximal end and a distal end. An engagement member adapted for disposition adjacent to annulus clip is disposed at the distal end of the pole. An adjacent lever is positioned along the shaft of the pole to engage the plunger on a side of annulus opposite the engagement member. The lever is operable to move the plunger from the free position to the locked position, thereby permitting the movable engagement of the operating section of the clip to the base section of the clip.

These noted features and advantages of the invention will be more apparent with a discussion of preferred embodiments and reference to the associated drawings.

### DESCRIPTION OF THE DRAWINGS

FIG. 1 is a side elevation view of a structure and a system for mounting Christmas lights or banners along the eve of the structure;

FIG. 2 is an axial cross-section exploded view of a clip including a base portion and an operating portion adapted for use in an embodiment of the invention;

FIG. 3 is a side elevation view partially in cross-section and showing a preferred embodiment for mounting the base section or the clip to the eve of the house;

FIG. 4 is a bottom plan view taken along lines 44 of FIG. 3

FIG. 5 is a side elevation view illustrating a sub-assembly including operating sections of two clips, a wire joining the clips, and a string of Christmas lights clipped to the wire in an embodiment of the invention;

FIG. 6 is a side elevation view of a remote mounting system including an elongate pole, U-shaped engagement member, and associated lever for mounting the operating section of the clips;

FIG. 7 is a plan view taken along lines 7-7 of FIG. 6; and

FIG. 8 is a side elevation view similar to FIG. 5 and illustrating a further embodiment including two engagement members on the elongate pole.

### DETAILED DESCRIPTION OF THE PREFERRED EMBODIMENTS AND BEST MODE OF INVENTION

A building structure, such as a house, is designated generally in FIG. 1 by the reference numeral 10. The house 10 has an eve 12 typically formed by a facia board 14 near the roofline of the house 10. A support system 16 associated with the invention is adapted for use in supporting an elongate object such a string of lights 18 or a sign or banner 21. This system 16 includes a plurality of clips 23, which are operatively disposed between the eve 12 and the string of lights 18 or banner 21, as described in greater detail below.

In this case, the house 10 is merely representative of any structure along which one might choose to support the elongate object such as the string of lights 18 or the banner 21. This structure might include any building, in which case the object might be supported from an eve of the building, such as the eve 12 of the house 10, or a balcony or windowsill, for example. The structure, such as the house 10, might also include a trellis or other frame used to support the object.

The clips 23 and 25 will typically have the same construction. By way of example, the clip 23 is illustrated in the exploded view of FIG. 2 and includes a base section 27 and operating section 30. In this case, the base section 27 is formed as a cylinder 32 with a generally open-end 34, and a generally closed-end 36 with a hole 38. An inner annular recess 41 is formed in the cylinder 32 near the open-end 34. This base section 27 functions as a receiver for the operating section 30.

The operating section 30 also has a cylinder 41 sized and configured to be received in the cylinder 32 of the base section 27. This cylinder 41 has a distal end 43 that is closed, and a proximal end 45 characterized by annulus 47. The annulus 47 is apertured to receive a spring-biased plunger 50 having a concealed annular recess 52 and an exposed hole 54. One or more spherical balls 56 are supported by the cylinder 41 and movable between an outward position providing the operating section 30 with a diameter greater than that of the inner diameter of the cylinder 32, and an inward position providing the operating section 30 with a diameter less than the inner diameter of the cylinder 32.

In operation, the plunger 50 is depressed, upwardly in FIG. 2, until the annular recess permits the ball 54 to move into its inward position. With the operating section 30 having a diameter less than that of the cylinder 32, the operating section 30 can be moved into the base section 27. At this point, the plunger 50 can be released permitting the spring 53 to move the plunger 50 outwardly, downwardly in FIG. 2. This removes the annular recess 52 from the ball 54 forcing the ball 54 to its outward position, where it occupies the annular recess 33 in the base section 27. In this position, the balls 54 function to lock the operating section 30 within the base section 27.

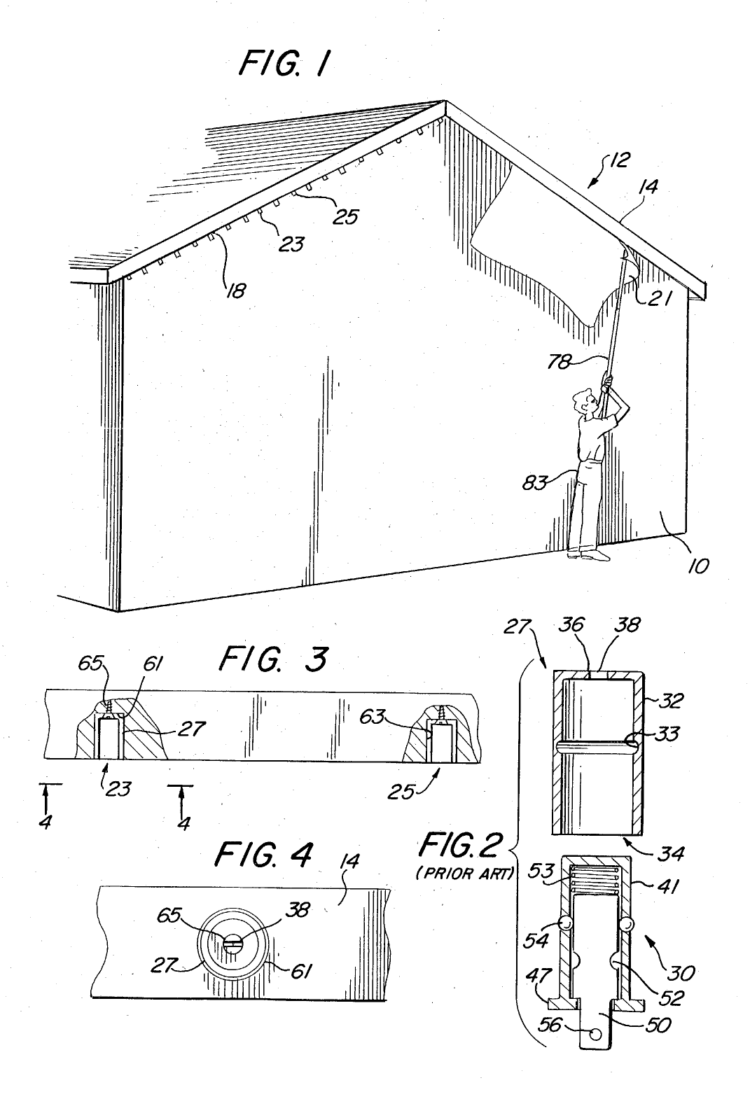

The clips 23 and 25 can be initially mounted in the facia board 14 in the manner illustrated in FIG. 3. In this particular embodiment, hole 61 and 63 can be drilled in the bottom surface of the facia board 14 and appropriately spaced along the facia board 14 to receive the base section 27 of the clip 23 and the clip 25. To hold the base section 23 within the hole 61, a screw 65 can be positioned through the hole 38 and screwed into the facia board 14. Since this base section 27 is to be permanently left in place, the provision of a suitable hole 61 will function to isolate the base section 27 from any rain.

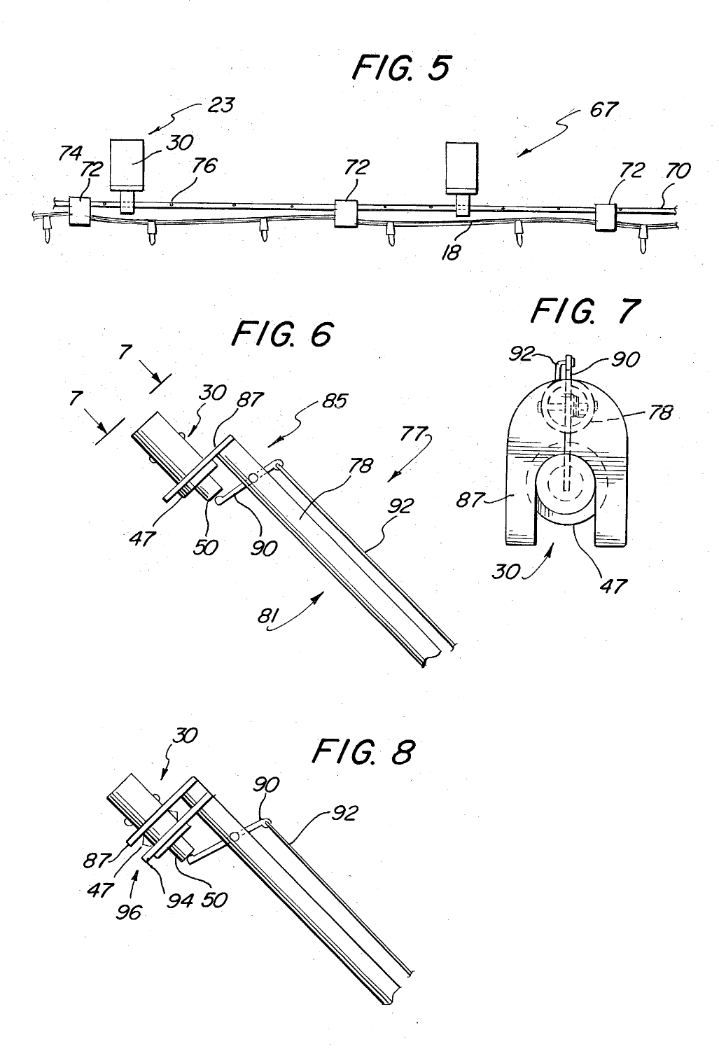

A sub-assembly 67 can be prepared as illustrated in FIG. 5. This sub-assembly 67 includes the operating section 30 of the clips 23 and 25. A cord, such as a wire 70, can be threaded through the holes 56 associated with the clips 23 and 25. The clips 23, 25 and the cord 70 become the support structure for the string of lights 18 or banner 21 to be hung along the eve 12 of the house 10 as illustrated in FIG. 1. In FIG. 5, the string of lights 18 is mounted directly to the wire 70 by plastic clips which are designated in FIG. 5 by the reference numeral 72. These clips 72 can be removable from the wire 70 in which case the supporting structure including the clips 23, 25 and the wire 70 is available to mount other objects, such as the banner 21. Alternatively, the string of lights 18 can be permanently attached to the wire 70 by the clip 72 in which case, the operating section 30 of the clips 23 and 25 are dedicated to the string of lights 18. Additional operating sections (not shown) would then be required to mount a different object, such as the banner 21, in the permanently placed base section 27. In a preferred embodiment, stops 74 are fixed to the wire 70 on either side of the clip 72 to insure that the string of lights 18 is maintained in a fixed position relative to the wire 70.

One significant advantage associated with the present invention, is its operability from ground level. As illustrated in FIG. 1, a person can mount the string of lights 18 or banner 21, using a remote mounting assembly such as that illustrated in FIG. 6. This assembly includes a long pole 78 having a proximal end 81 held by a user 83, and a distal end 85 for carrying and operating the operation section 30 of clips 23 and 25. A distal end of the remote operating system 77 is illustrated in FIG. 6. At the distal end 85, a U-shaped engagement member 87 can be provided to receive the operating section 30 of the clip 23 with the engagement member 87 disposed on the side of the annulus 47 opposite the exposed end of the plunger 50. A lever 90 can then be provided and pivotally mounted on the pole 78. One end of the lever is disposed in proximity to the plunger 50, while the other end of the lever 90 is adapted to receive tension element 92 which extends to the proximal end 81 of the pole 78.

In operation, the operating section 30 of the clip 23 can be mounted against the engagement member 87 and held in place by the lever 90. When the user 83 pulls on the tension member 92, the lever 90 depresses the plunger 50 thereby adapting it for insertion into the associated base section 27. All this can be accomplished from ground level thereby facilitating the safe and efficient mounting of the sub-assembly 67.

A further embodiment of the remote operating system differs from that illustrated in FIG. 6 in that it includes a second engagement member 94 which forms a pocket 96 with the engagement member 87 to receive the operation section 30 of the clip 23. This pocket 96 is sized and configured to receive the annulus 47 and to hold the clips in the remote operating system 77. The lever 90 and associated tension member 92 can then function in the manner previously discussed.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

1. A system for supporting an elongate object along the structure, comprising:
a first clip having a first base section and first operating section removably attached to the first base section;
a second clip having a second base section and a second operating section removably attached to the second base section;
means for attaching the first base section of the first clip to the structure;
means for attaching the second base section of the second clip to the structures in a space relationship with the first based section;
a cord coupled to the first operating section of the first clip and the second operating section of the second clip;
the first operating section being removably coupled to the first based section and the second operating section being removably coupled to the second base section to support the cord along the structure; and
the cord being adapted to support the elongate object along the structure.

2. The system recited in claim 1, when the structure is a house having an eve, and the system further comprises the first base section and the second base section being adapted for attachment to the eve of the house.

3. The system recited in claim 2, wherein the eve comprises a facia board having a hole and the first base section of the first clip is disposed in the hole.

4. The system recited in claim 1, wherein the first operating section is adapted to be removably received in the first base section in a coaxial relationship with the first base section.

5. The system recited in claim 1, wherein the elongate object comprises at least one of a banner and a string of lights.

6. The system recited in claim 1, wherein the cord is a wire.

7. The system recited in claim 1, further comprising:
a pair of stops fixed to the cord on either side of the first base section to maintain the first base section in a predetermined location along the cord.

8. A remote operating system for removably coupling an operating section of a clip to a base section of the clip, the operating section of the clip having an annulus and a plunger movable from a locked position to a free position to engage the base section of the clip, comprising:
an elongate pole having a proximal end and a distal end;
an engagement member adapted for disposition adjacent the annulus; and
a lever positioned on the shaft to engage the plunger on a side of an annulus opposite the engagement member, the lever being operable to move the plunger from the free position to the locked position.

9. The remote operating system recited in claim 8, wherein the engagement member is a first engagement member and the system further comprises:
a second engagement member adapted for disposition on the side of the annulus opposite the first engagement member to form a pocket sized and configured to receive the annulus of the operating section of the clip.

10. A method for removably supporting an elongate object along a structure, comprising the steps:
providing a first clip with a first base section and a first operating section removably attachable to the first base section, and a second clip with a second base section and a second operating section removably attachable to the second base section;
mounting the first base section and the second base section to the structure, in a spaced relationship along the structure;
stringing the first operating section and the second operating section on to a cord to create a sub-assembly;
attaching the elongate object to the cord; and
removably attaching the first operating section to the first base section and the second operating section to the second base section to removably support the cord and the object along the structure.
